(19) United States
(12) Patent Application Publication
(10) Pub. No.: US 2008/0043825 A1
(43) Pub. Date: Feb. 21, 2008

(54) XDSL MODEM TESTING SYSTEM AND METHOD THEREFOR

(75) Inventors: Yi-Tsai Chen, Tu-Cheng (TW); Chien-Ju Huang, Tu-Cheng (TW); Guo-Zhong Liu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,873

(22) Filed: Dec. 28, 2006

(30) Foreign Application Priority Data
Aug. 18, 2006 (TW) 95130439

(51) Int. Cl. H04B 1/38

(52) U.S. Cl. 375/222

(57) ABSTRACT

An xDSL modem testing method is provided. The xDSL modem testing method includes providing multiple script files, a script table for recording information of the script files, and a report table for recording test data; receiving multiple script files by a user interface module, each of the script files corresponds to each of the xDSL modems; parsing programs of each of the received script files according to the specifications, and the interface types of the testing system, the central offices, and the xDSL modems by a parsing module; determining whether all the received script files are executed, for determining whether the test process is completed by a controller; and terminating the test process, if the test process is completed. An xDSL modem testing system is also provided.

### BACKGROUND OF THE INVENTION

1. Field of the Invention

The present invention relates to a modem testing system and method, and particularly to an xDSL modem testing system and method.

2. Related of Prior Art

For automatically performing a physical layer testing on an xDSL modem, many manufacturers in the art design programs in source codes, which are in accordance with TR-048 or TR-067 specifications specified by the DSL FORUM and an interface of the xDSL modem testing system, to control the xDSL modem testing system. However, if the specifications and the interface are changed, the xDSL modem testing system programs designed in source codes should be modified correspondingly. Therefore, the xDSL modem testing system with programs designed in source codes is hard to maintain because these programs need to be modified frequently and only experienced programmers can perform the modification.

Therefore, a heretofore unaddressed need exists in the industry to overcome the aforementioned deficiencies and inadequacies.

### SUMMARY OF THE INVENTION

An xDSL modem testing system is provided. The xDSL modems testing system, employed to test interoperability of multiple xDSL modems and central offices, includes a first line switch, a second line switch, a line simulator, a first connecting device, a second connecting device, and a controller. The first line switch is connected to the xDSL modems, for switching connections between the xDSL modems and the central offices. The second line switch is connected to the central offices, for switching connections between the xDSL modems and the central offices. The line simulator is connected to the first line switch and the second line switch, for simulating communication environments between the xDSL modems and central offices. The first connecting device is connected to the xDSL modems. The second connecting device is connected to the central offices. The controller is connected to the first line switch, the second line switch, the line simulator, the first connecting device, and the second connecting device. Wherein the controller includes a saving module, and a parsing module. The saving module saves multiple script files, a script table for recording information of the script files, and a report table for recording test data. The parsing module parses the script programs according to the specifications, and the interface types of the testing system, the central offices and the xDSL modems.

An xDSL modem testing method is also provided. The xDSL modem testing method is implemented in an xDSL modem testing system, for testing interoperability of multiple xDSL modems and central offices. The xDSL modem testing method includes providing multiple script files, a script table for recording information of the script files, and a report table for recording test data; receiving multiple script files, each of which corresponds to each of the xDSL modems; parsing programs of each of the received script files according to the specifications, and the interface types of the testing system, the central offices, and the xDSL modems; determining whether all the received script files are executed, for determining whether the test process is completed; and terminating the test process, if the test process is completed.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is an xDSL modem testing system in accordance with an exemplary embodiment of the present invention;

FIG. 2 is a block diagram of the controller of FIG. 1;

FIG. 3 is a flowchart of an xDSL modem testing method implemented in the xDSL modem testing system of FIG. 1;

FIG. 4 is a flowchart of details of a step S330 of FIG. 3;

FIG. 5 is a flowchart of details of a step S336 of FIG. 4.

### DETAILED DESCRIPTION OF THE INVENTION

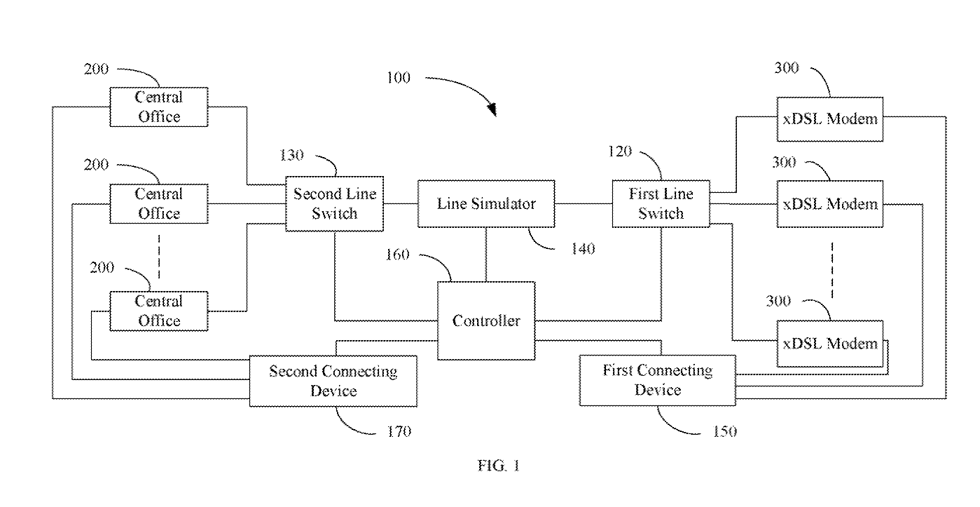

FIG. 1 is an xDSL modem testing system 100 in accordance with an exemplary embodiment of the present invention.

The xDSL modem testing system 100 is used to test interoperability between multiple communication devices like multiple xDSL modems 300 and central offices 200. The xDSL modem testing system 100 includes a first line switch 120, a second line switch 130, a line simulator 140, a first connecting device 150, a controller 160, and a second connecting device 170.

The first line switch 120 and the second line switch 130 includes multiple ports. The first line switch 120 is connected to the xDSL modems 300 and the line simulator 140 via communication wires. The second line switch 130 is connected to the central offices 200 and the line simulator 140 via the communication wires. The controller 160 controls the first line switch 120 and the second line switch 130 by parsing each script program for automatically switching connections between the xDSL modems 300 and the central offices 200.

The line simulator 140 is connected to the first line switch 120 and the second line switch 130 via the communication wires. The controller 160 controls the line simulator 140 by parsing corresponding script programs, and for simulating communication environments between the xDSL modems 300 and central offices 200. In this embodiment, the communication environments between the xDSL modems 300 and central offices 200 include various lengths and types of communication wires and various types of noise, such as white noise and 5T1 noise.

The controller 160 is connected to the first line switch 120 and the second line switch 130 via a peripheral component interconnect (PCI) interface, and connected to the line simulator 140 via a general-purpose interface bus (GPIB). Furthermore, the controller 160 is connected to the first connecting device 150 and the second connecting device 170 via Ethernet cables. In other exemplary embodiments, the controller 160 is connected to the first line switch 120 and the second line switch 130 via the GPIB interface or console interface.

The first connecting device 150 and the second connecting device 170 include multiple ports, and are respectively connected to the xDSL modems 300 and the central offices 200 via the Ethernet cables, for setting up connections between the xDSL modems 300 and the central offices 200. The first connecting device 150 and the second connecting device 170 further switch one interface to another interface. For example, the first connecting device 150 and the second connecting device 170 convert a console interface to a telnet interface. The first connecting device 150 and the second connecting device 170 may be hubs, switches, routers, multiple port switches, or a combination thereof.

In the exemplary embodiment, for identifying the xDSL modems 300 and the central offices 200, the controller 160 assigns a unique ID, such as a static and unique IP address or a port number, to each of the xDSL modems 300 and the central offices 200. When testing the xDSL modems 300, the controller 160 sends a command and captures data according to the IDs of the xDSL modems 300.

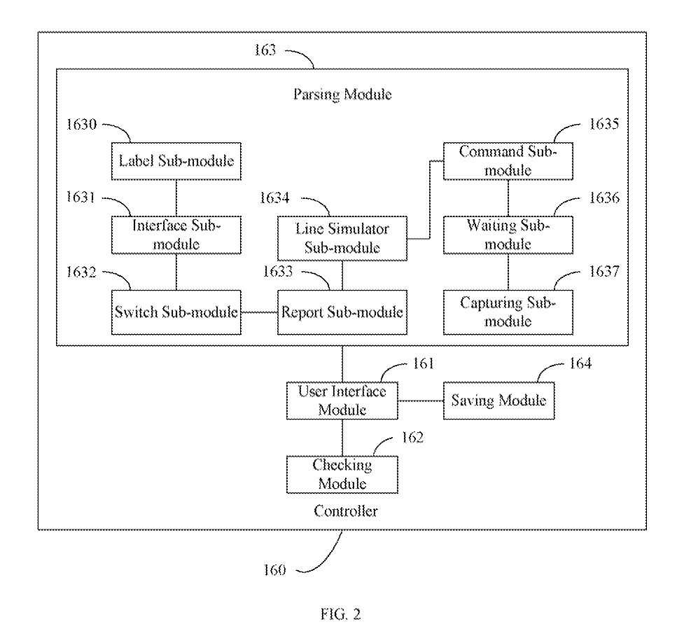

FIG. 2 is a block diagram of the controller 160 of FIG. 1.

In the exemplary embodiment, the controller 160 may be a computer as known in the art. The controller 160 has a hard drive, storing several test specifications according to various modem types. For example, if the modem testing system is used for testing ADSL (Asymmetric Digital Subscriber Line) modems, the controller 160 stores TR-048 or TR-067 specifications, both of which are specified by the DSL Forum.

The controller 160 includes a user interface module 161, a checking module 162, a parsing module 163, and a saving module 164.

The user interface 161 provides an interface for a user to control the modem testing system 100 by loading script files and observing test progress and test results.

The saving module 164 stores multiple script files, a script table for recording information of the script files, and a report table for recording test data. Each of the script files includes multiple script programs respectively corresponding to the test specifications, the interfaces of the testing system, the xDSL modems 300, and the central offices 200.

In the exemplary embodiment, the information in the script files include script program types, script program names, parameter values of the script programs, parameter types of the script programs, and label information, and so on. Script programs names correspond to script program types. Script program names include ‘Label’, ‘Init Com’, ‘Init Telnet’, ‘Init GPIB’, ‘Switch’, ‘Report’, ‘Line Simulator’, ‘Set’, ‘Wait’, and ‘Get’, and so on. The script program types include ‘0’, ‘1’, ‘2’, ‘3’ and so on. For example, the get script program corresponds to parameter type ‘3’. The parameter types of the script programs include a string, an integer, and so on. The parameter values of the script programs include port numbers of the interfaces. For example, a script program corresponding to the xDSL modem 300 includes parameter values of ‘COM1’ and ‘COM2’, indicating that the controller 160 captures data from the xDSL modem 300 according to the first COM port and the second COM port. The label information includes label names and line numbers of the labels, and so on.

The report table includes headers, including a loop field, a mode field, a channel field, a signal to noise (SNR) Field, and a rate field. The loop field records a length of the communication line between the xDSL modems 300 and the central offices 200, a line type, and a noise type. The mode field records a connection mode of the xDSL modems 300 and the central offices 200. The channel field records a channel type used by the xDSL modems 300 and the central offices 200. The SNR field records a SNR value of the line. The rate field records an upstream or a downstream rate of the xDSL modems 300 and the central offices 200.

In the exemplary embodiment, the controller 160 parses script programs according to the script program name to control the modem testing system 100, the central offices 200, and the xDSL modems 300. In other exemplary embodiments, the controller 160 parses script programs according to the script program type to control the modem testing system 100.

The checking module 162 automatically checks syntax of the script programs. In detail, the checking module 162 checks integrity, labels, names, parameter types and values of the script programs, and amount of parameter types thereof.

The parsing module 163 parses the script programs according to the specifications, and the interface types of the testing system 100, the central offices 200, and the xDSL modems 300. The parsing module 163 includes a label sub-module 1630, an interface sub-module 1631, a switch sub-module 1632, a report sub-module 1633, a line simulator sub-module 1634, a command sub-module 1635, a waiting sub-module 1636, and a capturing sub-module 1637.

The label sub-module 1630 records and saves label information of the script programs into the script table.

The interface sub-module 1631 initializes and closes interfaces of the line simulator 140, the first connecting device 150, the second connecting device 170, the central office 200, and the xDSL modem 300 by parsing corresponding script programs according to the interface types thereof. The interface types include COM interface, Telnet interface, HTTP (Hypertext Transfer Protocol) interface, and GPIB interface. Each of the script programs corresponds to each of the interface types and names thereof.

The switch sub-module 1632 initializes and closes interfaces of the first line switch 120 and the second line switch 130 by parsing switch script programs according to the interface types thereof. In the exemplary embodiment, the switch sub-module 1632 resets all the interfaces of the first line switch 120 and the second line switch 130, then opens the interfaces thereof corresponding to the central offices 200 and the xDSL modems 300 which are under test.

The report sub-module 1633 writes field names of the header of the report table by parsing the report script program, and records test data in accordance with test items into corresponding fields of the report table by parsing the report script program. Each of the test items respectively corresponds to a length of the communication line and type thereof, and a noise type.

The line simulator sub-module 1634 controls the line simulator 140 to simulate the communication environment between the xDSL modems 300 and the central offices 200 according to the interface types of the line simulator 140 by parsing the line simulator script program. In the exemplary embodiment, the interface types of the line simulator include the COM interface and the GPIB interface, and so on.

The command sub-module 1635 sends commands to the central offices 200 for setting test parameters of the central offices 200, via the first connecting device 150 by parsing the set script program. The testing parameters include upstream, downstream, and noise redundancy, and so on. The command sub-module 1635 further sends commands to the xDSL modems 300, via the second connecting device 170 by parsing the set script program for setting up connections between the xDSL modems 300 and the central offices 200.

The waiting sub-module 1636 starts waiting for connection mode by parsing the wait script program. During waiting for connection mode, the waiting sub-module 1636 determines whether connections are successfully set up between the xDSL modems 300 and the central offices 200. The waiting sub-module 1636 further records the number of times connection failed in the report table, and records information related to the failed connections in the report table. The waiting sub-module 1636 also times and records connection time of lasting connections between the xDSL modems 300 and the central offices 200.

The capturing sub-module 1637 captures test data from response data sent by the xDSL modems 300 and the central offices 200 by parsing the get script program. The captured data include the length of the communication line between the xDSL modems 300 and the central offices 200, the line type, the noise type, the connection mode, the channel type, the SNR, and the upstream or downstream rate.

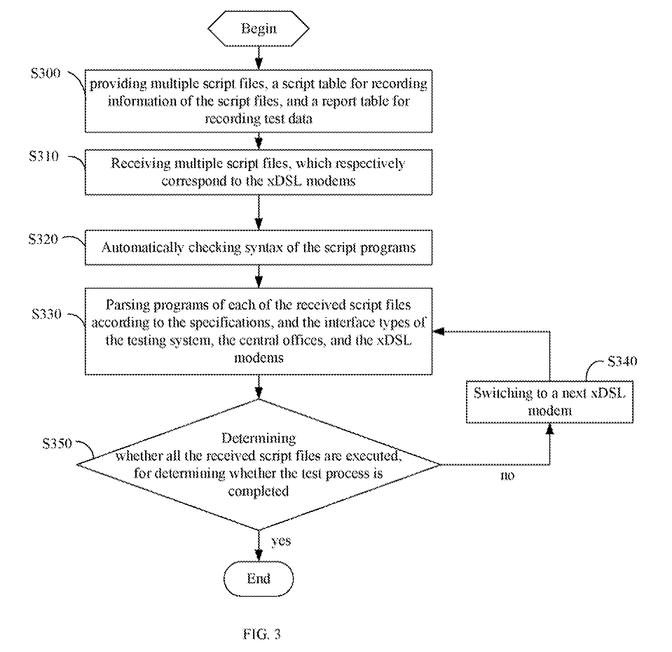

FIG. 3 is a flowchart of an xDSL modem testing method implemented in the above-described embodiment of xDSL modem testing system. The xDSL modem testing method is used to test interoperability of multiple xDSL modems 300 and central offices 200.

In step S300, providing multiple script files, a script table for recording information of the script files, and a report table for recording test data.

Each of the script files includes multiple script programs respectively corresponding to the test specifications, and the interfaces of the testing system, the xDSL modems 300, and the central offices 200.

In step S310, the user interface 161 receives multiple script files, which respectively correspond to the xDSL modems 300.

In the exemplary embodiment, each of the script files is in accordance with the interfaces of the xDSL modem testing system 100, the central offices 200, the xDSL modems 300, and the specifications.

In step S320, the checking module 162 automatically checks syntax of the script programs.

In the exemplary embodiment, the checking module 162 checks integrity, labels, names, parameter types, values of the script programs, and amount of parameter types thereof. If any error occurs in one of the script programs, the checking module 162 records the script program, and then continues to check a next script program.

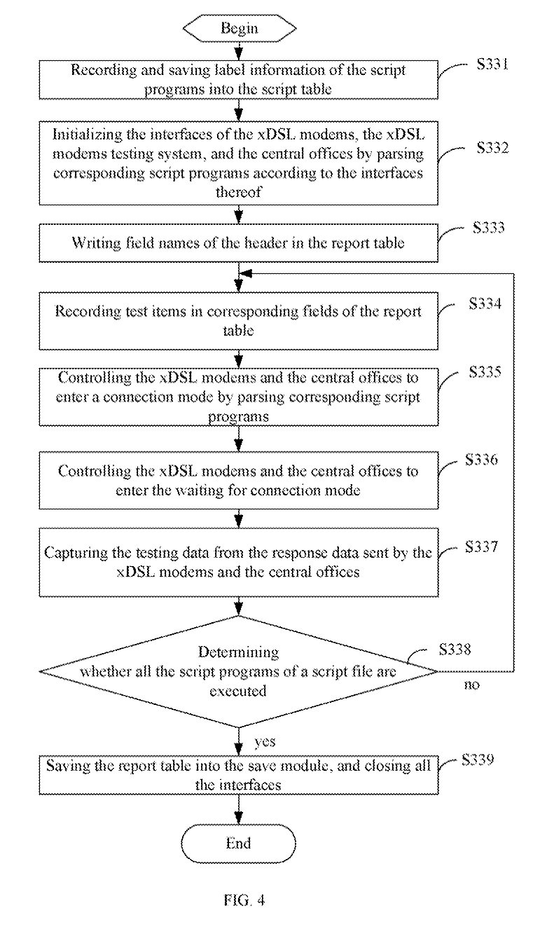

In step S330, the parsing module 163 parses programs of each of the received script files according to the specifications, and the interface types of the testing system 100, the central offices 200 and the xDSL modems 300. The detailed parsing process is shown in FIG. 4.

In the exemplary embodiment, the parsing module 163 parses the script programs according to the script program names; and the scrip program names are in accordance with the specifications, and the interface types of the testing system 100, the central offices 200, and the xDSL modems 300. In other exemplary embodiments, the parsing module 163 parses script programs according to the script program types.

In step S350, the controller 160 determines whether all the received script files are executed, for determining whether the test process is completed. If the test process is not completed, the process proceeds to step S340 to switch to the next xDSL modem 300. If the test process is completed, the test process terminates.

FIG. 4 is a flowchart of details of step S330, which is a step of parsing programs of each of the received script files according to the specifications, and the interface types of the testing system 100, the central offices 200, and the xDSL modems 300.

In step S331, the label sub-module 1630 records and saves label information of the script programs into the script table. In the exemplary embodiment, the label information includes the label names and line numbers of the labels, and so on. In the following process, the parsing module 161 parses the script programs according to the label information.

In step S332, the parsing module 161 initializes the interfaces of the xDSL modems 200, the xDSL modems testing system 100, and the central offices 300 by parsing corresponding script programs according to the interfaces thereof.

In the exemplary embodiment, the switch sub-module 1632 resets all the interfaces of the first line switch 120 and the second line switch 130, then opens the interfaces thereof corresponding to the central offices 200 and the xDSL modems 300 which are under test. Then the interface sub-module 1631 initializes and closes interfaces of the line simulator 140, the first connecting device 150, the second connecting device 170, the central offices 200, and the xDSL modems 300 by parsing corresponding script programs according to the interface types thereof.

In step S333, the report sub-module 1633 writes field names of the header in the report table.

In the exemplary embodiment, the report sub-module 1633 respectively writes names of ‘Loop’, ‘Mode’, ‘Channel’, ‘SNR’, and ‘Rate’ into the Loop field, the Mode field, the Channel field, the Signal to Noise (SNR) Field, and the Rate field.

In step S334, the report sub-module 1633 records test items in corresponding fields of the report table.

In the exemplary embodiment, each of the test items respectively corresponds to the length of the communication line and type thereof, and the noise type.

In step S335, the controller 160 controls the xDSL modems 300 and the central offices 200 to enter a connection mode by parsing corresponding script programs.

In detail, firstly, the line simulator sub-module 1634 controls the line simulator 140 to simulate the communication environment between the xDSL modems 300 and the central offices 200 according to the interface types of the line simulator 140 by parsing the line simulator script program; secondly, the command sub-module 1635 sends commands to the central offices 200 for setting test parameters of the central offices 200, via the first connecting device 150 by parsing the set script program; finally, the command sub-module 1635 further sends commands to the xDSL modems 300, via the second connecting device 170 by parsing the set script program for setting up connections between the xDSL modems 300 and the central offices 200.

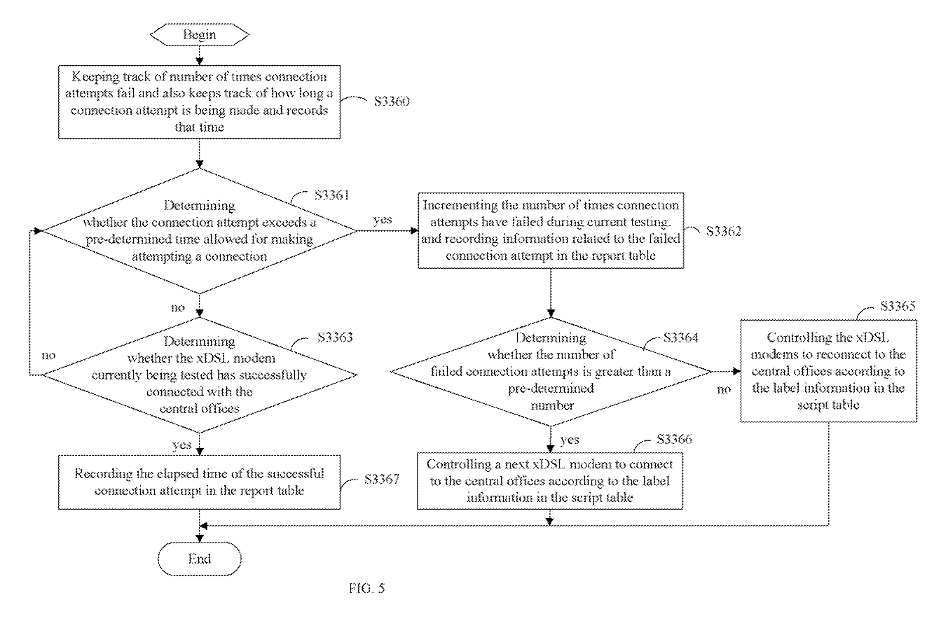

In step S336, the waiting sub-module 1636 controls the xDSL modems 300 and the central offices 200 to enter the waiting for connection mode. The waiting for connection mode is shown in FIG. 5 in detail.

In step S337, the capturing sub-module 1637 captures the test data from the response data sent by the xDSL modems 300 and the central offices 200.

In the exemplary embodiment, the captured data include the length of the communication line between the xDSL modems 300 and the central offices 200, the line type, the noise type, the connection mode, the channel type, the SNR, and the upstream or downstream rate. Then the report sub-module 1637 records the captured data into the report table.

In step S338, the parsing modules 163 determines whether all the script programs of a script file are executed, for determining whether the test process of one xDSL modem 300 is completed. If the test process is not completed, the process goes back to step S334. If the test process is completed, the test process proceeds to step S339.

In step S339, the report sub-module 1633 saves the report table into the save module 164, and the interface sub-module 1631 closes all the interfaces.

FIG. 5 is a flowchart of details of step S336, which is a step of entering the waiting for connection mode by parsing the wait script program.

In step S3360, the waiting sub-module 1636 keeps track of number of times connection attempts fail and also keeps track of how long a connection attempt is being made and records that time.

In step S3361, the waiting sub-module 1636 determines whether the connection attempt exceeds a pre-determined time allowed for making attempting a connection.

If the connection attempt has taken too long, the process proceeds to step S3362, where the waiting sub-module 1636 increments the number of times connection attempts have failed during current testing, and records information related to the failed connection attempt in the report table. Then the process proceeds to step S3364 to determine whether the number of failed connection attempts is greater than a pre-determined number. If the number is less or equal to than the pre-determined number, the process proceeds to step S3365, where the waiting sub-module 1636 controls the xDSL modems 300 to reconnect to the central offices 200 according to the label information in the script table. If the number is greater than the pre-determined number, then the xDSL modem 300 under test has failed, and the process proceeds to step S3366, where the waiting sub-module 1636 controls a next xDSL modem 300 to connect to the central offices 200 according to the label information in the script table.

In step S3361, if the connection has not taken too long, the process proceeds to step S3363, where the waiting sub-module 1636 determines whether the xDSL modem 300 currently being tested has successfully connected with the central offices 200. If unsuccessful, the process goes back to step S3361, if successful, the process proceeds to step S3367, where the report sub-module 1633 records the elapsed time of the successful connection attempt in the report table.

The xDSL modems testing system 100 and method thereof provided in the present invention are convenient to be maintained by employing different script programs according to the specifications, and the interface types of the xDSL modems testing system 100, the central offices 200, and the xDSL modems 300.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An xDSL modems testing system, for testing interoperability of multiple xDSL modems and central offices, comprising:
a first line switch connected to the xDSL modems, for switching connections between the xDSL modems and the central offices;
a second line switch connected to the central offices, for switching connections between the xDSL modems and the central offices;
a line simulator connected to the first line switch and the second line switch, for simulating communication environments between the xDSL modems and the central offices;
a first connecting device connected to the xDSL modems;
a second connecting device connected to the central offices; and
a controller connected to the first line switch, the second line switch, the line simulator, the first connecting device, and the second connecting device;
wherein the controller comprises:
a saving module for saving multiple script files, a script table for recording information of the script files, and a report table for recording test data; and
a parsing module for parsing the script programs according to the specifications, and the interface types of the testing system, the central offices, and the xDSL modems.

2. The xDSL modems testing system as recited in claim 1, wherein the information of the script files include script program types, script program names, parameter values of the script programs, parameter types of the script programs, and label information.

3. The xDSL modems testing system as recited in claim 2, wherein the controller parses script programs according to the script program names to control the modem testing system, the central offices, and the xDSL modems.

4. The xDSL modems testing system as recited in claim 1, wherein the communication environments between the xDSL modems and central offices include various lengths and types of the communication wires and various types of noise.

5. The xDSL modems testing system as recited in claim 1, wherein the controller assigns a unique ID for each of the xDSL modems and the central offices.

6. The xDSL modems testing system as recited in claim 5, wherein the first connecting device and the second connecting device may be hubs, switches, routers, multiple port switches, or combination thereof.

7. The xDSL modems testing system as recited in claim 1, wherein the controller further comprises:
a checking module for automatically checking syntax of the script programs; and
a user interface for providing an interface for a user to control the modem testing system.

8. The xDSL modems testing system as recited in claim 1, wherein the parsing module comprises:
a label sub-module for recording and saving label information of the script programs into the script table; and
a report sub-module for writing field names of the header in the report table, and recording test data in accordance with test items into corresponding fields of the report table.

9. The xDSL modems testing system as recited in claim 8, wherein the parsing module further comprises:
an interface sub-module for initializing and closing interfaces of the line simulator, the first connecting device, the second connecting device, the central office, and the xDSL modem according to the interface types thereof;
a switch sub-module for initializing and closing interfaces of the first line switch and the second line switch according to the interface types thereof; and
a line simulator sub-module for controlling the line simulator to simulate the communication environment between the xDSL modems and the central offices according to the interface types of the line simulator.

10. The xDSL modems testing system as recited in claim 9, wherein the parsing module further comprises:
a command sub-module for sending commands to the central offices and the xDSL modems for respectively setting test parameters of the central offices and the xDSL modems, via the first connecting device and the second connecting device respectively;
a waiting sub-module for entering a waiting for connection mode; and
a capturing sub-module for capturing test data from response data sent by the xDSL modems and the central offices.

11. An xDSL modem testing method, implemented in an xDSL modem testing system, for testing interoperability of multiple xDSL modems and central offices, the xDSL modem testing method comprising:
providing multiple script files, a script table for recording information of the script files, and a report table for recording test data;
receiving multiple script files by a user interface module, each of the script files respectively corresponds to each of the xDSL modems;
parsing programs of each of the received script files according to the specifications, and the interface types of the testing system, the central offices, and the xDSL modems by a parsing module;
determining whether all the received script files are executed, for determining whether the test process is completed by a controller; and
terminating the test process, if the test process is completed.

12. The xDSL modem testing method as recited in claim 11, further comprising a step of automatically checking syntax of the script programs by a checking module.

13. The xDSL modem testing method as recited in claim 11, further comprising a step of switching to a next xDSL modem, if the test process is not completed.

14. The xDSL modem testing method as recited in claim 11, wherein the step of parsing comprises:
recording and saving label information of the script programs into the script table by a label sub-module;
initializing the interfaces of the xDSL modems, the xDSL modems testing system, and the central offices by corresponding modules according to the interfaces thereof;
writing field names of the header in the report table by the report sub-module;
recording test items into corresponding fields of the report table by the report sub-module;
controlling the xDSL modems and the central offices to enter a connection mode by corresponding modules; and
controlling the xDSL modems and the central offices to enter the waiting for connection mode by a wait sub-module.

15. The xDSL modem testing method as recited in claim 14, wherein the step of controlling the xDSL modems and the central offices to enter a connection mode by corresponding modules comprises:
controlling a line simulator to simulate the communication environment between the xDSL modems and the central offices according to the interface types of the line simulator by a line simulator sub-module;
sending commands to the central offices for setting test parameters of the central offices, via the first connecting device by a command sub-module; and
sending commands to the xDSL modems, via the second connecting device and setting up connections between the xDSL modems and the central offices by the command sub-module.

16. The xDSL modem testing method as recited in claim 14, wherein the step of controlling the xDSL modems and the central offices to enter a waiting for connection mode by a wait sub-module comprises:
counting number of times connection attempts failed, and tracking and recording how long a connection attempt takes between the xDSL modems and the central offices by the wait sub-module;
determining whether the connection attempt exceeds a pre-determined time limit by the wait sub-module;
incrementing the number of failed connection attempts, and recording information related to the failed connection attempts in the report table by the wait sub-module, if the pre-determined time limit has been exceeded;
determining whether the number of failed connection attempts is greater than a pre-determined number by the wait sub-module;
controlling the xDSL modems to reconnect to the central offices according to the label information recorded in the script table by the wait sub-module, if the number of failed connection attempts is less than or equal to the pre-determined number; and
controlling a next xDSL modem to reconnect to the central offices according to the label information in the script table by the wait sub-module, if the number of failed connection attempts is greater than the pre-determined number.

17. The xDSL modem testing method as recited in claim 16, wherein the step of controlling the xDSL modems and the central offices to enter a waiting for connection mode by a wait sub-module further comprises:
determining whether the xDSL modems successfully connected with the central offices by the wait sub-module, if the pre-determined time limit has not been exceeded;
continuing to determine whether the pre-determined time limit has been exceeded by the wait sub-module, if the connection has not succeeded yet; and
recording amount of time used in a successful connection attempt in the report table by the report sub-module.

18. The xDSL modem testing method as recited in claim 11, wherein the step of parsing includes parsing the script programs according to the script program names to control the modem testing system, the central offices and the xDSL modems by the parsing module.

19. A method for testing interoperability of multiple communication devices, comprising:
retrieving multiple user-definable script files, each of which corresponds to a communication device out of multiple communication devices to be tested, for testing said multiple communication devices, respectively;
checking syntax of said each of multiple script files; and
parsing said each of received script files to execute said testing of said multiple communication devices according to said each of multiple script files, correspondingly.

20. The method as recited in claim 19, further comprising a step of recording information of said each of multiple script files into a script table, and recording test data in a report table.
